(19) United States
(12) Patent Application Publication
(10) Pub. No.: US 2014/0089503 A1
(43) Pub. Date: Mar. 27, 2014

(54) Automatic Connection Selection

(71) Applicants: Tomas Thyni, Jarfalla (SE); Mats Forsman, Ronninge (SE)

(72) Inventors: Tomas Thyni, Jarfalla (SE); Mats Forsman, Ronninge (SE)

(73) Assignee: TELEFONAKTIEBOLAGET L M ERICSSON (PUBL), Stockholm (SE)

(21) Appl. No.: 14/113,867

(22) PCT Filed: Apr. 29, 2011
(86) PCT No.: PCT/SE2011/050540

§ 371 Date: Nov. 18, 2013

(51) Int. Cl. H04L 29/08

(52) U.S. Cl. CPC H04L 67/141
USPC 709/224

(57) ABSTRACT

The proposed Automatic Connection Selection (ACS) uses the domain name system (DNS) look up as the detection mechanism to indicate if the access connection is working or not. The DNS servers are centralized in the operator's network and reachability to these are a good indication of a working connection.

### TECHNICAL FIELD

This document relates to a method and a communications device for supporting and monitoring multi-access connection functionality.

### BACKGROUND

A communications device, such as a User Equipment or a Customer Premises Equipment, is configured to establish a connection to other communications devices and/or nodes via one or more communications networks. Said networks comprise switches and/or routers for establishing a connection for transferring data communication traffic of data packets between communications devices. A connection may also be denoted link, communication link, logical link, physical link, path, data path, communication path, etc.

A connection may also comprise an access connection between a communications device and an access network. An access network is that part of a communications network which connects subscribers/users to their immediate service provider. An access connection may be a wired connection or wireless connection. Examples of wired connections are copper cable or optical fiber. A radio link is a typical wireless connection. Many different access standards and access technologies are known, e.g. 3GPP (Third Generation Partnership Project), UTRA (UMTS Terrestrial Radio Access), W-CDMA (Wideband Code Division Multiple Access), CDMA2000 (Code Division Multiple Access 2000), GSM (Global System for Mobile Communication), UMTS (Universal Mobile Telecommunications system), LTE (Long Term Evolution), WiFi, WiMAX, Ethernet, xPON (Passive Optical Network), xDSL (Digital Subscriber Line).

The service providers offer connection to Internet via their access networks. An access connection for the Internet connection is therefore established between a user's communications device and an edge node of the service provider's access network. Said access network comprises a gateway to which a user/subscriber is directed. Said gateway is sometimes called a default gateway. In a communications network, a gateway is a network node equipped for interfacing and routing traffic between nodes in the same network or other networks. A gateway may contain devices such as network address translators, impedance matching devices, rate converters, fault isolators, or signal translators as necessary to provide system interoperability. Thus, connection providing signalling and data communications traffic transported in different protocols and via different communications networks between different communications devices in different nodes or points of the networks are possible by means of said gateways, routers and switches.

A communications device having multi-access connection functionality, or multiple access connectivity, is capable of and configured to establish access connections via several access networks. A user of the communications device has therefore the possibility to manually select a preferred access connection of the several different access connections that are available. When the user starts its user device, a network set up procedure is performed wherein the preferred access connection is established as it is weighted as a primary access connection. Said primary access connection is therefore always selected by the communications device as long as it is available and it has an IP address assigned.

However, communications failure may occur along the way of a connection between two points of said communications networks. One problem is that an access connection is considered to be working as long as the access connection has been authenticated and an IP address has been assigned the communications device, even if a failure occurred somewhere above, i.e. upstream, said default gateway making the connection unusable. Thus, the communications device will remain connected to said access connection even though a number of other access connections are available and working. When a user of the communications device notices the problem, the user has to manually switch to a working access connection.

There are existing solutions trying to address this by sending “keep-alive” messages in the form of ping messages. Ping is a computer network administration utility used to test the reachability of a host on an Internet Protocol (IP) network and to measure the round-trip time for messages sent from the originating host to a destination computer. Ping operates by sending Internet Control Message Protocol (ICMP) echo request packets to a target host and waiting for an ICMP response. In the process it measures the time from transmission to reception, denoted round-trip time, and records any packet loss. The results of the test are printed in form of a statistical summary of the response packets received, including the minimum, maximum, and the mean round-trip times, and sometimes the standard deviation of the mean.

Ping may be run using various options (command line switches) depending on the implementation that enable special operational modes, such as to specify the packet size used as the probe, automatic repeated operation for sending a specified count of probes, time stamping options, or to perform a ping flood. Flood pinging may be abused as a simple form of denial-of-service attack, in which the attacker overwhelms the victim with ICMP echo request packets.

Too frequent use of ping towards any network device or server can lead to the owner of the device turning off the possibility to respond to ping for specific or all addresses. And this leads to the detection mechanism being unusable. There are also other types of keep-alive techniques available, but said known methods require a set-up of a relationship between the devices, and is only used between operator/service provider controlled devices.

### SUMMARY

One object is to provide a solution of the above discussed problems.

Said object is achieved by embodiments of a method for supporting multi-access connection functionality of a communications device configured to send over one or more access connections one or more Domain Name Server Queries to Domain Name Servers. Said method comprises sending a Domain Name Server Query to a Domain Name Server and a sub-process of detecting a communications failure of an access connection used for data communication by monitoring reception of one or more expected Domain Name Server Responses related to the sent Domain Name Server Queries over said access connection used for data communication. The method may also comprise a sub-process of selecting according to a selection criterion a working access connection for data communication.

Said object may also be achieved by a communications device supporting multi-access connection functionality, and which is configured for sending over one or more access connections one or more Domain Name Server Queries to Domain Name Servers. The communications device may comprise a controller configured to detect a communication failure of an access connection used for data communication by monitoring reception of one or more expected Domain Name Server Responses related to the sent Domain Name Server Queries over said access connection used for data communication. The controller may further be configured to select according to a selection criterion a working access connection for data communication.

A number of embodiments of said method and a communications device are further described in the following detailed description.

One advantage with the present solution is that it provides automatic detection and selection of best possible working connection.

Further, a number of advantages will become discussed in the following detailed description.

### BRIEF DESCRIPTION OF THE DRAWINGS

The foregoing, and other, objects, features and advantages of the present invention will be more readily understood upon reading the following detailed description in conjunction with the drawings in which:

FIG. 1 is a block diagram of an exemplary network in which proposed embodiments of methods, functional blocks, and devices described herein may be implemented;

FIG. 2 is a schematic block diagram illustrating a Customer Premises Equipment, according to prior art.

FIG. 3 is a block diagram illustrating some embodiments of a proposed communications device;

FIG. 4 is a block diagram illustrating some embodiments of a proposed communications device;

FIG. 5 is a flowchart of embodiments of the proposed method.

FIG. 6 is a block diagram illustrating embodiments of a controller 150 configured to perform the method steps of embodiments of the present Automatic Connection Selection functionality.

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art how the present invention and other embodiments that depart from these specific details may be practiced. In other instances, detailed descriptions of well known methods, devices, and circuits are omitted so as not to obscure the description of the present invention with unnecessary detail.

The proposed Automatic Connection Selection (ACS) uses the domain name system (DNS) look up as the detection mechanism to indicate if the access connection is working or not. The DNS servers are centralized in the operator's network and reachability to these are a good indication of a working connection. DNS, Domain Name System translates domain names meaningful to humans, such as “www.example.com” into IP-addresses associated with networking equipment for the purpose of locating and addressing these devices worldwide.

For example, the domain name www.example.com translates to the addresses 192.0.32.10 (IPv4) and 2620:0:2d0:200:10 (IPv6).

A DNS Client in a communications device is configured to send a DNS query to one or more designated DNS servers. In the case of most communications devices, the Internet Service Provider (the ISP to which the device connects) will usually supply this DNS server: the server's address is either set manually or is set by means of a Dynamic Host Configuration Protocol (DHCP) or similar function.

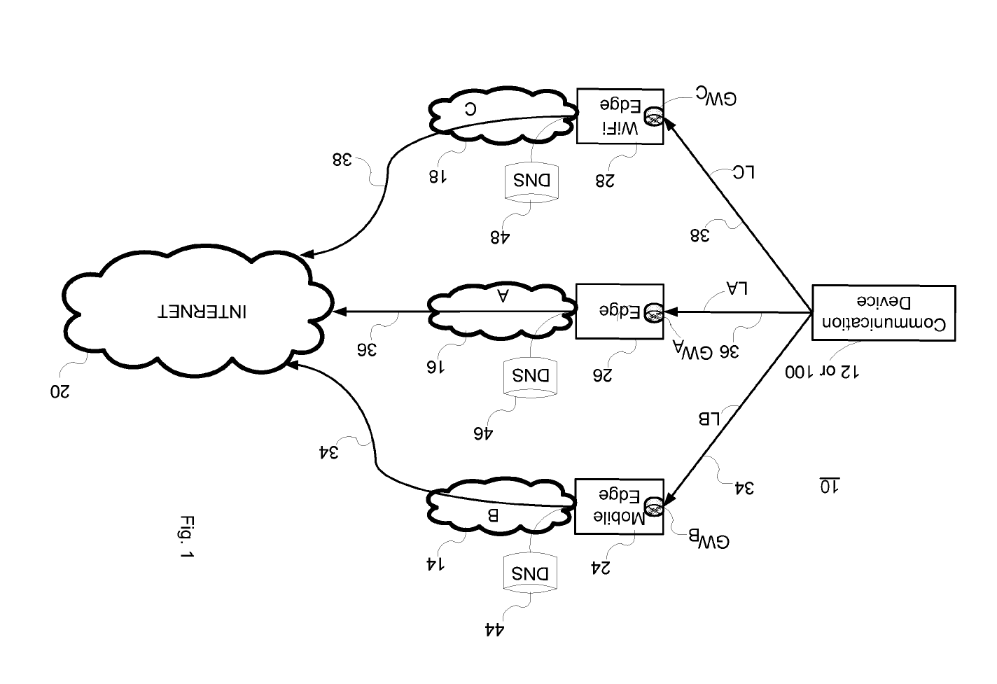

FIG. 1 is an illustration of an exemplary network 10 in which embodiments of methods, functional blocks, and devices described herein may be implemented.

A communications device 12, 100 has multiple connections options for establishing connectivity via a number of access networks, which allow further access to other networks, such as e.g. the Internet. Reference number 12 refers to a communication device according to prior art, while reference number 100 refers to a communication device implementing proposed embodiments of solutions of the object to be achieved.

The communications device 12, 100 may have fixed connection options or wireless connection options. Examples of fixed connection options are e.g. point-to-point (P2P) Ethernet over fiber, Digital Subscriber Line (over copper) xDSL, Passive Optical Network (over fiber) EPON, GPON, etc. Examples of wireless connections, are e.g. mobile telecommunication, mobile cellular telecommunication, Mobile BroadBand (MBB), WiMAX, Free Space Opto, etc. Thus, a fixed connection involves some kind of wire for transferring data communication traffic. Wireless connection involves communication via an air interface by means of radio or optical transmitters and receivers.

The communications device 12, 100 has multiple connection functionality, which means that the device is configured to communicate with other devices via different access connection technologies and standards. The communications device 12, 100 is supporting simultaneous multiple access connection to different subnets.

The communications device 12, 100 may be any type of User Equipment, e.g. Personal Computer, laptop, smart phone, mobile phone, etc. The communications device 12, 100 may also be a Customer-premises equipment or customer-provided equipment (CPE). The CPE is any terminal and associated equipment located at a subscriber's premises and connected with a carrier's telecommunication channel(s) at the demarcation point (“demarc”). The demarc is a point established in a building or complex to separate User Equipment from service provider equipment. The CPE is configured to connect at least one User Equipment to an External network and to transfer and direct data communication traffic, e.g. routing data packets.

CPE generally refers to customer owned telephones, routers, switches, Residential Gateways, RGWs, or purchased set-top boxes for use with Communications Service Providers' services. Also included are key telephone systems and most private branch exchanges.

In the illustrated example of FIG. 1, there is provided one IP subnet 14, 16, 18 per access technology. Each access technology may involve multiple default gateways allowing connectivity for the communications device. Each access connection LA, LB, LC to a gateway GW in a subnet has been dedicated a weight W, also denoted cost, which differs from the other weights W of other connections. Said weights are stored in the communications device 12. A weight or cost W is a parameter indicating the priority of a connection, i.e. how preferred a connection is. According to some embodiments, the communications device is configured to select the access technology with the lowest weight, or cost, as the most preferred connection. The lower weight a connection is dedicated, the more preferred the connection is. The weight or cost may be set in relation to a certain preferences, or connection feature, such as the bandwidth of the connection—high bandwidth corresponds to a low cost and low bandwidth corresponds to a high cost.

However, if the communications device 12, 100 is configured to select the access technology with the highest weight W, or cost, as the most preferred connection. The higher weight a connection is dedicated, the more preferred the connection is—high bandwidth corresponds to a high cost and low bandwidth corresponds to a low cost.

Due to the multiple connection functionality, a number of possible access subnets and connections may be available and/or provided. As illustrated in the example in FIG. 1, three different access subnets 14, 16, 18 are available. One access subnet 14 is a mobile cellular access network comprising an access node 24 comprising a node-B or base station. On the cellular network, the communications device 12, 100 communicates over an air interface with a base station, through a base station controller, to servers in the core network of the carrier. The communication standards used are for example GSM/GPRS (General Packet Service Radio), UMTS, LTE mobile services. The edge node comprises a gateway GW_{B}, which can be a GGSN/PDN-GW, i.e. Gateway GRS Support Node/Packet Data Network Gateway or similar. An access connection LB is established between the communications device and the GGSN/PDN-GW. The communications device 12, 100 is configured to connect to the Internet 20 for sending and receiving data communication traffic, e.g. data packets, via said access connection LB and gateway GW_{B} along the connection 34, of which access connection LB is a part. Said access connection also provides accessibility to one or more DNS Servers 44 in the subnet 14.

The communications device 12, 100 is also able to establish a fixed and wired connection, LA, 36 with an edge node 26 of a fixed access subnet 16. Said edge node comprises a Gateway GW_{A} to which the fixed and wired access connection LA is connected. The Gateway is preferably a router. The communications device 12 is configured to connect to the Internet 20 for sending and receiving data communication traffic, e.g. data packets, via said access connection LA and gateway GW_{A} along the connection 36, of which access connection LB is a part. Said access connection also provides accessibility to one or more DNS Servers 46 in the subnet 16.

Further, the communications device 12, 100 is capable of connecting to a Wi-Fi access subnet 18. The communications device 12, 100 signals for establishing a wireless access connection LC to an WiFi Edge 28 via an access point—often called hotspot—of the Wi-Fi access subnet 18. Said edge 28 comprises a Gateway GW_{C} to which the connection LC 38 is connected. The communications device is configured to connect to the Internet 20 for sending and receiving data communication traffic, e.g. data packets, via said access connection LC and gateway GW_{C} along the connection 38, of which access connection LC is a part. Said access connection also provides accessibility to one or more DNS Servers 48 in the subnet 18.

Said Gateways GW_{A} and GW_{C} may be implemented as routers for routing data packet traffic.

Routers that incorporate a digital subscriber line modem, or a cable modem and a Wi-Fi access point, is often set up in homes and other premises, and can provide Internet access and internetworking to all devices connected (wirelessly or by cable) to them.

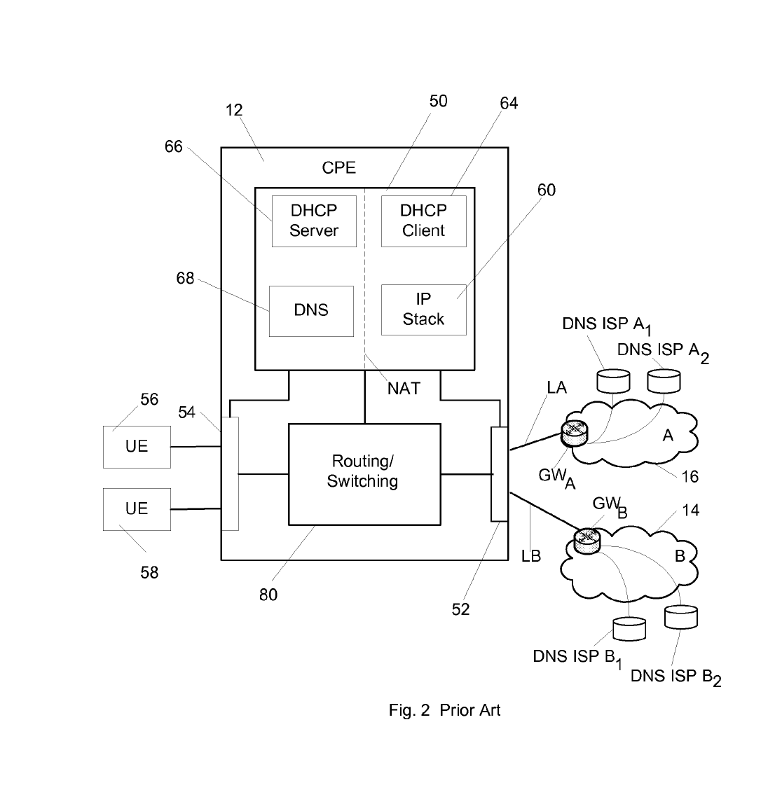

FIG. 2 is a schematic block diagram illustrating an example of a communications device 12 according to prior art. The communications device is a Customer Premises Equipment CPE, which is configured to connect a number of end-user devices 56, 58, herein denoted as User Equipment UE, to a number of subnets 14, 16 of Service Providers A, B. Upstream and downstream data communication traffic, e.g. data packets and signalling, are switched or routed by a routing/switching functionality block 80 to the correct destinations, either one of the UEs 56, 58 or a device or node via access networks 14, 16. The routing/switching functionality block 80 is controlled by a controller 50, which may be a processor or processing unit comprising one or more digital processors.

The device 12 may further comprise a network interface 52 and an end-user interface 54. The network interface 52 comprises input ports and output ports and necessary circuitry, e.g. filters, antennas, transmitters, receivers, transceivers, for handling connections and data traffic with the Internet Service Providers, ISPs, access networks 14, 16. Two access networks 14, 16, are illustrated in the example, one handled by internet service provider A, ISP A, and the other by Internet Service Provider B, ISP B. ISP A is handling network 16 and ISP B is handling network 14. In the illustrated example, interface 52 handles the access connections LA and LB Access connection LA connects the communications device 12 to the gateway GW_{A} of ISP network A 16. Access connection LB connects the communications device 12 to the gateway GW_{B} of ISP network B 14. The end-user interface 54 comprises input ports and output ports and necessary circuitry, e.g. filters, antennas, transmitters, receivers, transceivers, for handling connections and data traffic with the two illustrated user equipments 56, 58. The controller 50 is configured to control the interfaces 52, 54 and their circuitry and other components and the upstream and downstream data communication traffic and signalling.

The controller 50 is configured to handle a plurality of different functionalities of the device. Only a number of said functionalities are of special interest for the present embodiments, which are described hereafter in the following description. Said functionalities are presented as functionality blocks in the enclosed and appended drawings of the embodiments.

One such functionality block of special interest is the Internet Protocol stack, IP stack 60, which comprises and handles a routing table. The IP stack 60 is also configured to handle and store IP addresses and the processes related to the IP addresses.

Different Access Methods for retrieving IP addresses may be used:
Dynamic IP/DNS Address allocation such as Dynamic Host Configuration Protocol (DHCP), Stateless Address Auto-Configuration and Router Advertisement (SLAAC/RA), Point-to-Point Protocol (PPP) or similar; and/or
Static IP/DNS Address configuration, as well.

The controller 50 controls a DHCP Client 64 which provides the IP stack with IP addresses. A Network Address Translation NAT may also be provided which translates Public IP number to local home IP numbers, and vice versa. The local IP addresses are handled by DHCP server functionality, illustrated as block 66. The DHCP server is situated on the “local” or “home” side and it is configured to distribute the local addresses to different User Equipments 56, 58 connected to the end-user interface 54. Further, the controller 50 is provided with DNS functionality, illustrated as a block 68. Said block 68 may either be implemented as a DNS proxy or a DNS client, as well. It is logically situated on the “local” side of the controller. The DNS block 68 comprises and handles a DNS table and the processes for storing data and retrieving stored data in the DNS table

The Dynamic Host Configuration Protocol DHCP is an auto configuration protocol used on IP networks. Communications devices that are connected to IP networks must be configured before they can communicate with other devices on the network. DHCP allows a computer to be configured automatically, eliminating the need for intervention by a network administrator. It also provides a central database for keeping track of communications devices that have been connected to the network. This prevents two devices from accidentally being configured with the same IP address.

Alternatively IPv6 hosts may use stateless address auto-configuration and router advertisement to generate an IP address and configure available DNS servers. IPv4 hosts may use link-local addressing to achieve limited local connectivity.

In networking, the Point-to-Point Protocol, or PPP, is a data link protocol commonly used in establishing a direct connection between two networking nodes. It can provide connection authentication, transmission encryption privacy, and compression.

PPP is used over many types of physical networks including serial cable, phone line, serial cable, cellular telephone, specialized radio links, and fiber optic links such as SONET. Most Internet service providers use PPP for customer dial-up access to the Internet. Two encapsulated forms of PPP, Point-to-Point Protocol over Ethernet (PPPoE) and Point-to-Point Protocol over ATM (PPPoA), are used most commonly by Internet Service Providers (ISPs) to establish a Digital Subscriber Line (DSL) Internet service connection with customers.

PPP is commonly used as a data link layer protocol for connection over synchronous and asynchronous circuits, where it has largely superseded the older Serial Line Internet Protocol (SLIP) and service provider mandated standards (such as Link Access Protocol, Balanced (LAPB) in the X.25 protocol suite). PPP was designed to work with numerous network layer protocols, including Internet Protocol (IP), Novell's Internetwork Packet Exchange (IPX), NBF and AppleTalk. PPP is also used over broadband connections

In the illustrated example, the controller 50 handles a DHCP Client 64 which provides the IP stack 60 with IP addresses. When establishing a connection a set up process is performed, wherein the DHCP client 64 is configured to send a request message for an IP address, which is provided by the Internet Service Provider, for a certain connection. Thus, the DHCP client sends such an IP request message for each connection for a multi connection adapted communication device. The ISP replies with a response message comprising, e.g.:
External IP address of the CPE, usually a public IP address;
Gateway, GW, IP address;
DNS IP address(es);

Said IP addresses are transferred to the IP stack to be stored.

The controller 50 is schematically and functionally, but not physically, divided into one part handling the public Internet Protocol addresses and the internal local addresses, home addresses, for the user equipments connected to the communications device 12. This interface between the two parts is denoted the Network Address Translation NAT and is used for translate Public IP number to local home IP numbers, and vice versa. Functionalities handling the public Internet Protocol addresses are situated on one side and the functionalities handling the internal local addresses on the other side of the interface, illustrated with a dashed line in FIG. 2. The internal local addresses are not valid as public addresses and are not used on or distributed to the “public” side of the NAT.

The local addresses are handled by a DHCP server functionality, illustrated as block 66. The DHCP server is situated on the “local” or “home” side and it is configured to distribute the local addresses to different User Equipments connected to the end-user interface 54, either via a fixed line connected to a port of the interface or via a wireless link, e.g. a radio link, via radio equipment of the interface.

The DNS functionality block 68 comprises and handles the DNS table and the processes for storing data and retrieving stored data in the table.

The DNS functionality block 68 stores the ISP DNS addresses in a DNS table and will therefore be able to reply to DNS questions, i.e. queries, regardless which ISP a UE 56, 58 is connected to. The DNS functionality is configured to receive DNS queries from the users, i.e. the UEs, via the end-user interface 54 and to generate and send the query messages to the correct DNS server DNS ISP A₁, DNS ISP A₂, DNS ISP B₁, DNS ISP B₂ (44, 46, 48 in FIG. 1) as it has the information, i.e. IP address. The response message with the reply, or requested information, from the DNS server is handled by the DNS functionality 68, which forwards the requested information to the requesting UE.

According to established CPE operation, the DHCP signalling process during the network set up process provides the DNS table with the DNS destinations, i.e. the DNS IP addresses. The DNS table contains a first DNS address DNS ISP A₁ and a second address DNS ISP A₂. The first DNS address is considered as a first choice DNS server for the CPE and the second address as a back-up if the first DNS server fails to respond. It is a common practice from the network operator to provide accessibility to one or more DNS servers for the connected communications devices.

At the set up process with 2 ISPs, e.g. operator ISP A and operator ISP B, the DHCP signalling process during the network set up process provides the CPE with the DNS IP addresses for each ISP. However, the DNS functionality 68 is configured to store the DNS IP addresses in a DNS table for only one of the operators at a time due to the fact that the IP stack only sets one ISP address, i.e. port in the interface, as active.

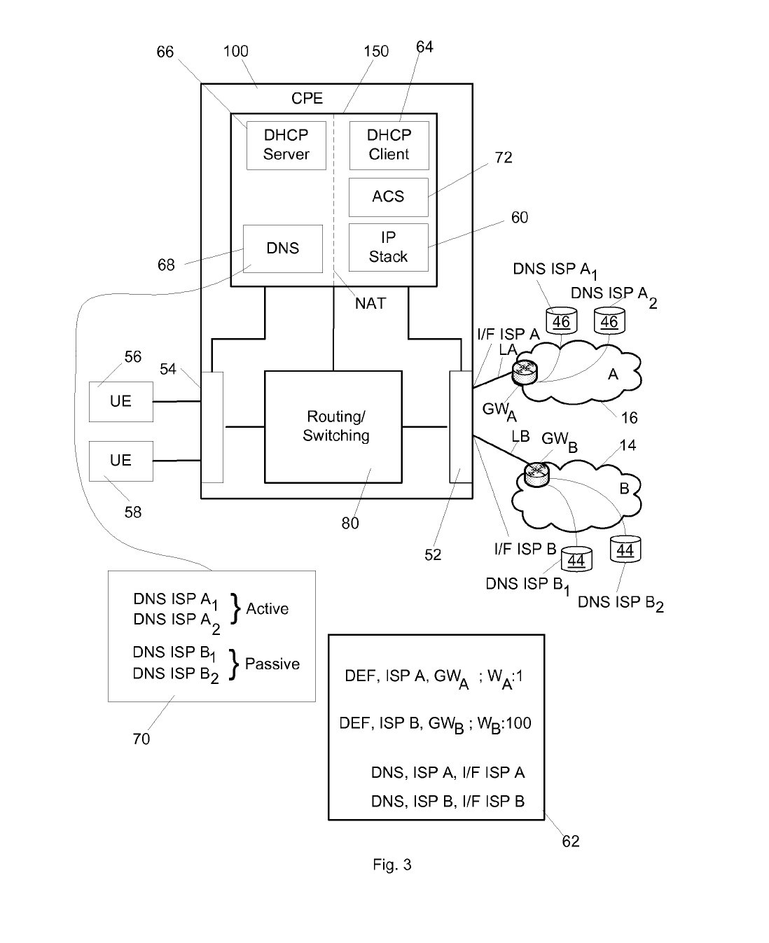

FIG. 3 is a block diagram illustrating some embodiments of a communications device 100. The illustrated embodiment is a Customer Premises Equipment, CPE.

The communications device 100 is a Customer Premises Equipment CPE, which is configured to connect a number of end-user devices 56, 58, herein denoted as User Equipment UE to a number of subnets 14, 16. Upstream and downstream data communication traffic, e.g. data packets, and signalling are switched or routed by a routing/switching functionality block 80 to the correct destinations, either one of the UEs 56, 58 or a device or node via access networks 14, 16. The routing/switching functionality block 80 is controlled by a controller 150, which may be a processor or processing unit comprising one or more digital processors.

The communications device 100 may further comprise a network interface 52 and an end-user interface 54. The network interface 52 comprises input ports and output ports and necessary circuitry, e.g. filters, antennas, transmitters, receivers, transceivers, for handling connections and data traffic with the Internet Service Providers, ISPs, access networks 14, 16. Two access networks 14, 16, or subnets, are illustrated in the example, one handled by internet service provider A, ISP A, and one handled by Internet Service Provider B, ISP B. ISP A is handling network 16 and ISP B is handling network 14. In the illustrated example, the network interface 52 comprises an interface I/F ISP A associated with a connection 36 (see FIG. 1) of which access connection LA is a part. The network interface 52 also comprises an interface I/F ISP B associated with a connection 34 (see FIG. 1) of which access connection LB is a part. Access connection LA connects the communications device 12 to the gateway GW_{A} of ISP network A 16. Access connection LB connects the communications device 12 to the gateway GW_{B} of ISP network B 14. The end-user interface 54 comprises input ports and output ports and necessary circuitry, e.g. filters, antennas, transmitters, receivers, transceivers, for handling connections and data traffic with the two illustrated user equipments 56, 58. The controller 150 is configured to control the interfaces 52, 54 and their circuitry and other components and the upstream and downstream data communication traffic and signalling.

The controller 150 is configured to handle a plurality of different functionalities of the device 100. Only a number of said functionalities are of special interest for the present invention and embodiments thereof, which are presented hereafter in the following description. Said functionalities are presented as functionality blocks in the enclosed and appended drawings of the embodiments.

One such functionality block of special interest is the Internet Protocol stack, IP stack 60, which comprises and handles a routing table 62. The IP stack 60 is also configured to handle and store IP addresses and the processes related to the IP addresses.

Different Access Methods for retrieving IP addresses may be used:
Dynamic IP/DNS Address allocation such as DHCP, Stateless Address Auto-Configuration and Router Advertisement (SLAAC/RA), Point-to-Point Protocol (PPP) or similar; and/or
Static IP/DNS Address configuration, as well.

The controller 150 controls a DHCP Client 64 which provides the IP stack with IP addresses. A Network Address Translation NAT may also be provided which translates Public IP number to local home IP numbers, and vice versa. The local addresses are handled by DHCP server functionality, illustrated as block 66. The DHCP server 66 is situated on the “local” or “home” side and it is configured to distribute the local addresses to different User Equipments connected to the end-user interface 54. Further, the controller 150 is provided with DNS functionality, illustrated as a block 68. Said block 68 may either be implemented as a DNS proxy or a DNS client, as well. It is logically situated on the “local” side of the controller. The DNS block 68 comprises and handles a DNS table 70 and the processes for storing data and retrieving stored data in the table 70.

The communications device implements a Domain Name System, DNS, functionality towards the internal clients in the home network. The clients behind the communications device will only see the communications device as a DNS server. Said DNS functionality is common in many routing communications devices.

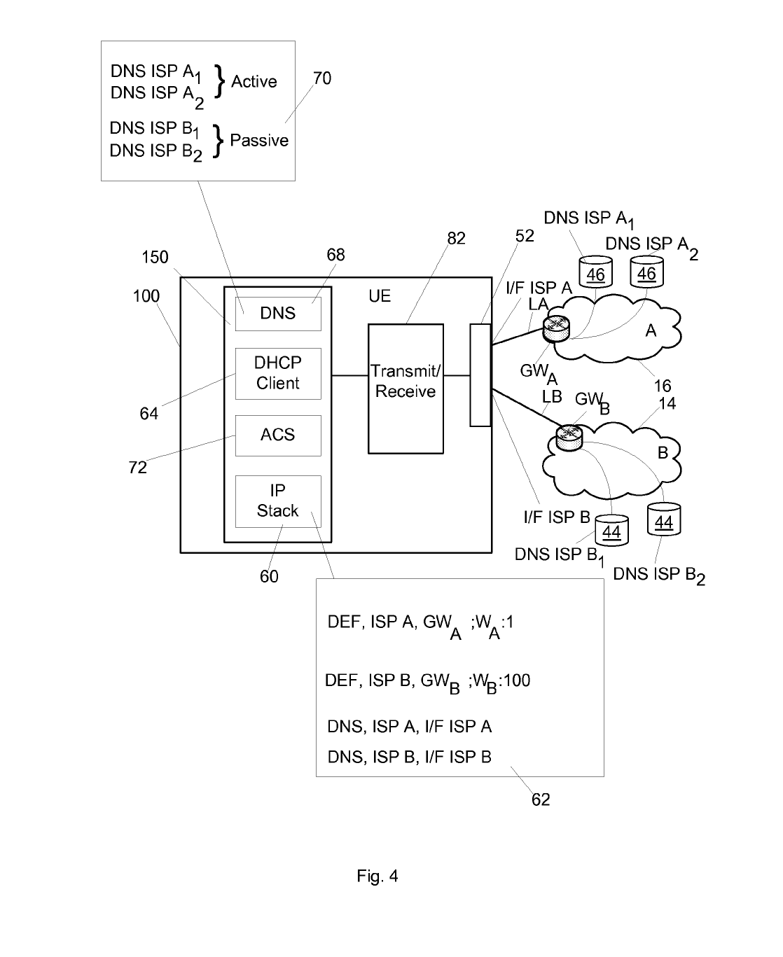

For providing automatic detection and selection of best possible working connection to a device communicating via the Internet, the communications device is provided with Automatic Connection Selection (ACS) functionality, block 72. How the new functionality block interacts with said known elements for solving the problem is described in more detail further down together with the description of another kind of communications device 100, which is illustrated in FIG. 4.

FIG. 4 is a block diagram illustrating some other embodiments of a communications device 100. The illustrated embodiment is a User Equipment, UE, which is configured to connect to a number of subnets 14, 16. The UE may be a smart phone, laptop, mobile phone, etc. Upstream and downstream data communication traffic, e.g. data packets, and signalling via the access connections LA, LB are sent and received by a transmit/receive functionality block 82, which comprises transceivers, transmitters and receivers circuitry. The transmit/receive functionality block 82 is controlled by a controller 150, which may be a processor or processing unit comprising one or more digital processors.

The communications device 100 may further comprise a network interface 52. The network interface 52 comprises input ports and output ports and necessary circuitry, e.g. filters, antennas, and other circuitry, for handling connections and data traffic with the Internet Service Providers, ISPs, access networks 14, 16. Two access networks 14, 16, or subnets, are illustrated in the example, one handled by internet service provider A, ISP A, and Internet Service Provider B, ISP B. ISP A is handling network 16 and ISP B is handling network 14. In the example, ISP A provides two DNS servers DNS ISP A₁ and DNS ISP A₂, both indicated 46. Further, ISP B provides two DNS servers DNS ISP B₁ and DNS ISP B₂, both indicated 44.

In the illustrated example, the network interface 52 comprises an interface I/F ISP A associated with a connection 36 (see FIG. 1) of which access connection LA is a part. The network interface 52 also comprises an interface I/F ISP B associated with a connection 34 (see FIG. 1) of which access connection LB is a part. Access connection LA connects the communications device 12 to the gateway GW_{A} of ISP network A 16. Access connection LB connects the communications device 12 to the gateway GW_{B} of ISP network B 14. The controller 150 is configured to control the interface 52 and its circuitry and other components and the upstream and downstream data communication traffic and signalling.

The controller 150 is configured to handle a plurality of different functionalities of the device. Only a number of said functionalities are of special interest for the present invention and embodiments thereof, which are presented hereafter in the following description. Said functionalities are presented as functionality blocks in the enclosed and appended drawings of the embodiments.

One such functionality block of special interest is the Internet Protocol stack, IP stack 60, which comprises and handles a routing table 62. The IP stack 60 is also configured to handle and store IP addresses and the processes related to the IP addresses.

Different Access Methods for retrieving IP addresses may be used:
Dynamic IP/DNS Address allocation such as DHCP, Stateless Address Auto-Configuration and Router Advertisement (SLAAC/RA), Point-to-Point Protocol (PPP) or similar; and/or
Static IP/DNS Address configuration, as well.

The controller 150 controls a DHCP Client 64 which provides the IP stack with IP addresses. Further, the controller 150 is provided with DNS functionality, illustrated as a block 68. Said block 68 may either be implemented as a DNS proxy or a DNS client, as well. The DNS block 68 comprises and handles the DNS table 70 and the processes for storing data and retrieving stored data in the table 70.

For providing automatic detection and selection of best possible working connection to a device communicating via the Internet, the communications device 100 is provided with Automatic Connection Selection (ACS) 72 functionality. Said ACS function is common for the different embodiments of communications device 100.

According to an embodiment of the ACS 72, the DNS table 70 and the IP stack routing table 62 are generated during the Network set up process, but the DNS table 70 and the routing table 62 according to the proposed embodiments are not similar to prior art DNS tables and routing tables. One difference is that all addresses for sending DNS Query messages are registered in the DNS table, either as “active” or as “passive”, depending on the weight of the connection to an ISP, see example Table 1: DNS table after set up. As illustrated in the tables below, DNS ISP A₁ and DNS ISP A₂, are set to “active” as their addresses are related to DEF ISP A, GW_{A} which connection has the lowest weight, W_{A}:1, compared to DEF ISP B, GW_{B} which connection has the weight, W_{B}:100. The ACS 72 is configured to set the activity status in the DNS table due to the current connection weight W set in the IP stack routing table. If the connection weight W is changed, the activity status may be changed, which is described further down.

Each time a DNS Query is generated and sent to one of the DNS servers which addresses are indicated as active in the DNS table. Subsequent DNS Query can be sent to the same active DNS server or load-balance between multiple active servers.

TABLE 1
DNS table after set up 70 in FIGS. 3, 4 and 6

| | |
|---|---|
| DNS ISP A₁ | Active |
| DNS ISP A₂ | Active |
| DNS ISP B₁ | Passive |
| DNS ISP B₂ | Passive |

Further, the controller 150 of the communications device 100 is configured to generate an IP stack routing table 62, wherein it is defined whereto the data traffic comprising the data packets should be sent, i.e. which gateway of an edge node of the access net the data traffic should be addressed for further routing in said net. As an example, see Table 2, the connection between the communications device forwarding data packets and the address “Def ISP A, GW_{A}” has the weight W_{A}:1 and the connection between the communications device forwarding data packets and the address “Def ISP B, GW_{B}” has the weight W_{B}:100. Further, the ACS 72 is configured to provide the routing table with “static routing” posts, even denoted static routing rules, defining where to DNS queries should be sent regardless the weights of the different connections of the communications device 100 for the posts in the DNS table set to active state. According to the example of routing table, table 2, when the DNS block 68 addresses DNS queries for an operator ISP A and for ISP B set to action status “active”, the controller 150 of the communications device 100 is configured to send the DNS queries on all connections indicated as “static routing”. If all DNS servers, i.e. their addresses, are set to active, the IP stack routing table 62 directs the DNS queries on the different connections, respectively, according to the addresses.

TABLE 2
Start IP stack routing table after set up 62 in FIGS. 3, 4 and 6

| | |
|---|---|
| Def ISP A, GW_{A} | W_{A}: 1 |
| Def ISP B, GW_{B} | W_{B}: 100 |
| DNS, ISP A, I/F ISP A | Static routing |
| DNS, ISP B, I/F ISP A | Static routing |

The Automatic Connection Selection function 72 provides a possibility to monitor connections operation, especially if a connection is up or down, i.e. due to communication failure. According to some embodiments, the ACS 72 is monitoring the sending of one or more DNS Queries via an interface to one or more access networks on each connection for sending digital data packets with information over the internet (20 in FIG. 1). The ACS 72 is also configured to handle the setting of active and passive states of the DNS addresses in the DNS table 70. Further, the ACS 72 is configured to handle the connection weights in the IP stack routing table 62 and the static routing rules, as described above.

The ACS function 72 monitors both sending of DNS queries and reception of corresponding DNS response on an active connection.

In the illustrated examples of FIGS. 3 and 4, the connection between the communications device 100 forwarding data packets and the address “Def ISP A, GW_{A}” is the connection Link A. LA, and the connection between the communications device 100 forwarding data packets and the address “Def ISP B, GW_{B}” is the connection Link B. LB. The active connection is connection LA, as LA has the lowest weight W, W_{A}:1, as indicated in the routing table 62 of the IP stack, and generated DNS queries are sent over said connection LA to the DNS A₁ or DNS A₂, as they are set as active in the DNS table, see example in table 1.

During the monitoring of the connections, each generated and sent DNS query may be waited for and registered when received for monitoring if the connection is up and operating. If one or more DNS responses are not received on a connection supposed to be active, i.e. up and functioning, the ACS will start a process for finding and selecting a working connection.

Failure Detection

In the following example, the communication via link LA to the DNS servers does not work, and sent DNS queries will not be received by the DNS server or the response is not received by the ACS 72.

When the ACS 72 detects that one or more DNS responses are missing, the ACS is configured to set all DNS addresses in the DNS table 70 as active, as illustrated in table 3, new DNS table. When the next DNS Query is generated, either automatically or by one of the users, DNS Queries addressed to all DNS servers are generated. As the static routing rules for DNS queries in IP stack routing table, e.g. Table 2, are valid, said DNS Queries addressed to all DNS servers are sent to the DNS servers via the interface I/F ISP A, which is connected to link LA, and the interface I/F ISP B connected to link LB.

TABLE 3
New DNS table 70 in FIGS. 3, 4 and 6

| | |
|---|---|
| DNS ISP A₁ | Active |
| DNS ISP A₂ | Active |
| DNS ISP B₁ | Active |
| DNS ISP B₂ | Active |

The ACS is configured to register each received DNS response on any of the connections.

In this example, communication via access connection LA (connection 36 in FIG. 1) is still broken and down, but the communication via access connection LB (connection 34 in FIG. 1) is up and running. Therefore, there will be no DNS responses received by the interface I/F ISP A connected to access connection LA from the DNS servers DNS A₁ and DNS A₂, in the net of ISP A. However, one of the DNS servers DNS B₁ has responded. A DNS response is received via connection LB on the interface I/F ISP B. The ACS registers that a DNS response is received via connection LB on the interface I/F ISP B. The ACS is therefore configured to change the connection weights W of the connections LA and LB in the routing table, here Table 2, wherein the connection LA corresponds to the address Def ISP A, GW-A and connection LB corresponds to the address of DNS, ISP B, I/F ISP B. The transmitting of data traffic from CPE is now ruled and controlled by a new CPE routing table, see table 4: New CPE routing table

TABLE 4
New CPE routing table 62 in FIGS. 3, 4 and 6

| | |
|---|---|
| Def ISP A, GW_{A} | W_{A}: 100 |
| Def ISP B, GW_{B} | W_{B}: 1 |
| DNS, ISP A, I/F ISP A | Static routing |
| DNS, ISP B, I/F ISP B | Static routing |

ISP A Works Again

However, in the DNS table all DNS server addresses are set to active, as the communications device 100 has a number of default values for the weights of the connections, the communications device 100 keeps the DNS addresses as active as long as the current weights of the connections in the routing table are changed. In this case, the primary connection, which is defined as the most preferred access connection is not used

A DNS query from a user results in a DNS query to each DNS server represented in the table 70 and the static routing rules in the CPE routing table 62 control the communications device 100 to send the DNS queries over all access connections.

Queries to each addressed DNS server on both interfaces, I/F ISP A and I/F ISP B, and corresponding connections LA and LB.

When the communication via connection LA is up and operating, i.e. running, DNS responses are received via connection LA on the interface I/F ISP A. The ACS registers that a DNS response is received via connection LA on the interface I/F ISP A. As this connection is the connection with the lowest weight W as a default value, because the access connection LA is pre-set as most preferred connection, or primary access connection the ACS function 72 is configured to change the connection weights W_{A} and W_{B} of the connections LA and LB in the IP stack routing table 62, see table 2. As the weights of the connections has been reset to the default values for the connections, the ACS 72 is configured to set the addresses DNS ISP A1 and DNS ISP A2 in the DNS table as active, and the addresses DNS ISP B1 and DNS ISP B2 in the DNS table as passive. The transmitting of data traffic from the communications device 100 is now ruled and controlled by a start IP stack routing table 62, see table 2, as illustrated.

The communications device 100 is using its best connection LA again and the ACS 72 is configured to monitor failure of connection LA by sending DNS queries and receiving DNS responses over LA.

According to some embodiments of the communications device 100 involving ACS functionality 72, a processor unit or a set of processor units of a controller 150, of the communications device 100, is configured to detect a communication failure of an access connection used for data communication by monitoring reception of one or more expected Domain Name Server Responses related to said sent Domain Name Server Queries over said access connection used for data communication, and to selecte according to a selection criterion an access connection for data communication. Said controller 150 may further be configured to send one or more Domain Name Server Queries to all or a number of the DNS servers which is represented in a DNS table 70 in the communications device 100. Said controller 150 may further be configured to set the DNS servers addresses in the DNS table in an active state. Each of said access connections may be dedicated a weight corresponding to performance features, such as bandwidth, bit rate, etc, of the connection and the selection criterion is to select the access connection with the lowest weight to be used for data communication. Alternatively, each of the access connections have been dedicated a weight W corresponding to performance features of the connection and the selection criterion is to select the working access connection with the highest weight W to be used to be used for data communication. The processor unit may also be configured to change or mutually switch between the access connections the weights W of the access connections are changed or mutually switched between the access connections when an access connection for data communication have been selected according to said selection criterion. If a primary access connection is pre-set as default at a set up process, said controller 150 may be configured to redirect the data communication back to the primary access connection, if another connection is used than the primary connection for data communication, and a DNS response is received on the primary connection.

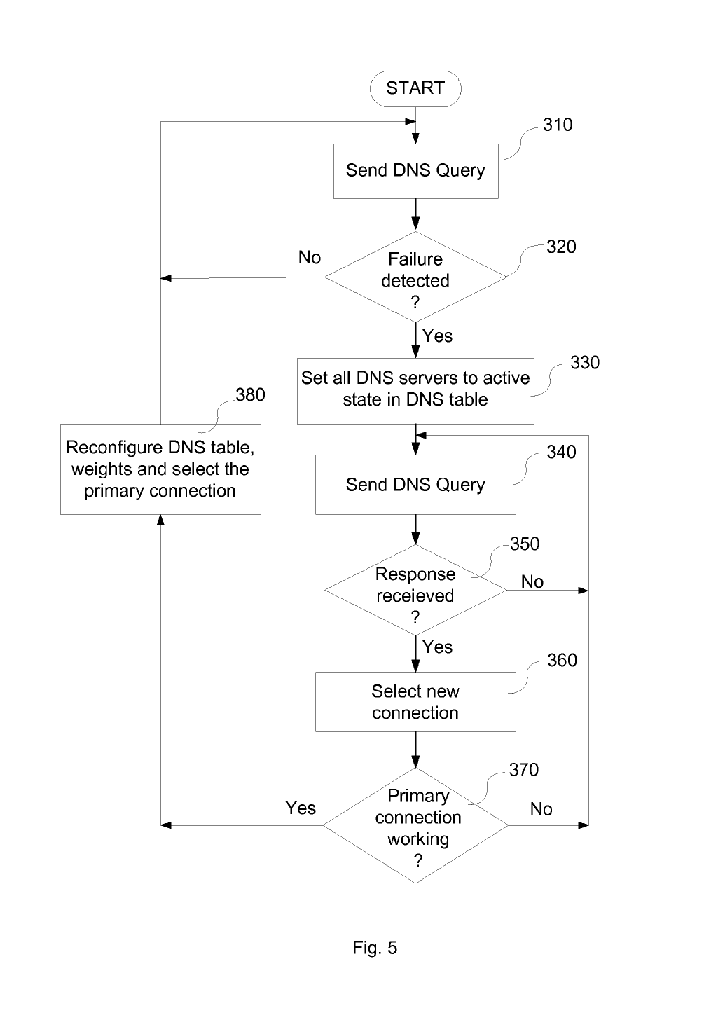

The above described embodiments of the communications device are configured to perform embodiments of a method for supporting multi-access connection functionality to a number of networks. Said embodiments are hereafter descried with reference to FIG. 5.

FIG. 5 is a flowchart of some embodiments of the proposed method.

Said communications device 100 is configured to perform an Automatic Connection Selection process which is a monitoring process for monitoring whether one or more access connection(s) of selectable access connections are working, or not.

After the network set up process has been finalized, the communications device 100 is connected to at least one access connection. Some embodiments of the present method comprise:

Step 310: Send DNS Query: —Sending one or more Domain Name Server Queries to DNS servers over one or more access connections. The DNS Query may be generated automatically and/or periodically by the communications device 100 itself or by a user by means of a user equipment UE 56, 58 connected to the communications device 100. As already described, each DNS query is addressed by the DNS block 68, either a DNS proxy or a DNS client, and directed to the correct interface port or ports of the network interface 52 and the connected access connection. As default, the access connection having the lowest weight or cost is selected for sending the DNS Query. Usually, the access connection having the lowest weight or cost is the connection providing the best service and communication condition, such as highest bandwidth, etc. However, if the access connection having the highest weight or cost is the connection providing the best service and communication condition, than the selection criterion is to select the connection with the highest weight or cost. The access connection that is selected by default is here denoted as the primary connection or primary access connection.
Step 320: Failure detected?: —Detecting a communication failure for an access connection used for data communication by monitoring reception of one or more expected Domain Name Server Responses related to said sent Domain Name Server Queries over said access connection used for data communication. The controller 150 of the communications device 100 is configured to monitor the DNS Queries and DNS Responses by registering that a DNS is sent to a certain DNS Server via a certain access connection, in this case the primary connection, and that a DNS Response from said DNS server is received from said DNS server via said primary connection. If “No”, the expected DNS is received and the controller 150 and its ACS functionality is configured to monitor the sending and reception according to said “No”-loop of steps 310 and 320. If “Yes” a communication failure is detected, i.e. the primary connection is down, and a new access connection has to be selected, and the process therefore continues with step 330.
Step 330: Set all DNS servers to active state in DNS proxy table: —Setting the DNS servers' addresses in the DNS table in an active state. The DNS table in the DNS proxy comprises DNS server addresses as descried. The DNS server addresses may have different states, “active” or “passive”, see e.g. table 1. The controller is configured to set by means of its ACS functionality these states. In passive state, a DNS address in the passive state will not be used for sending DNS queries. A DNS address in the active state is used for sending DNS queries. When all DNS addresses are set to active state, see e.g. table 3 above, DNS queries are generated for all DNS servers.
Step 340: Send DNS query: —Sending one or more Domain Name Server Queries to all or a number of the DNS servers which is represented in a DNS table in the communications device. The IP stack routing table, see e.g. table 2 and 4, is used for controlling the routing of data packet traffic to a special interface port. As described, the routing table is provided with “static routing” posts which are routing rules defining where to DNS queries should be sent regardless the weights of the different connections of the communications device. Thus, the DNS queries are sent on all the access connections defined by said “static routing” posts of the IP stack routing table, e.g. table 2.
Step 350: Response received? The controller 50 with ACS functionality is configured to monitor all interface ports and access connections for received DNS responses. Each received response is registered, and working, i.e. active, access connections are indicated and registered.
Step 360: Select working access connection: —Selecting according to a selection criterion an access connection for data communication. The controller 150 with ACS functionality 72 is configured to select one of the active indicated access connections according to a selection criterion. The access connection having the lowest weight or cost is selected for sending the DNS Query. Usually, the access connection having the lowest weight or cost is the connection providing the best service and communication condition, such as highest bandwidth, etc. However, if the access connection having the highest weight or cost is the connection providing the best service and communication condition, than the selection criterion is—select the connection with the highest weight or cost. The controller 150 with ACS functionality is configured to change or mutually switch the weights of the access connections between the access connections when an access connection for data communication has been selected according to said selection criterion. The access connection that is selected by default is denoted as the primary connection or primary access connection. In IP stack table, table 2, the connection ISP A, GW_{A} has the weight W_{A}:1 and is by default the primary connection. In the same table, the connection ISP B, GW_{B} has the weight W_{B}:100 and it is therefore a secondary connection. In the IP stack table, table 4, the connection ISP A, GW_{A} has the weight W_{A}:100 due to the detected communication failure and, the active connection ISP B, GW_{B} has been assigned the weight W_{B}:1.
Step 370: Primary connection working?: If another connection is used than the primary connection, the sending of DNS Queries on all ports of the interface and connected connections, according to step 340, and the monitoring of all interface ports and access connections for received DNS responses, see step 350, continue as long as no DNS response is received on the primary connection. The controller with ACS functionality is configured to reconfigure the settings in the tables back to set up position, in step 380, if a DNS response is received, detected and registered on the primary access connection, i.e. “yes” in the flowchart,
Step 380: Reconfigure DNS table, weights and select the primary connection. A DNS response is received, detected and registered by the controller 150 with ACS functionality, and the controller 150 is configured to reconfigure from another temporary used connection to the preferred primary access connection. In the DNS table, see example table 3, all DNS server addresses were set to active, and all connections were monitored for DNS responses. When reconfiguring the DNS table, the DNS addresses are set in to passive state except for the DNS addresses related to the primary connection, which DNS addresses are kept in the active state, as illustrated in table 1. Further, the controller with ACS functionality is configured to change or mutually switch the weights of the access connections in the IP stack table back to the default setting, i.e. reconfiguring said tables and access connection weights. In the IP stack table, table 4, the connection ISP A, GW_{A} has the weight W_{A}:100 due to the detected communication failure and, the active connection ISP B, GW_{B} has been assigned the weight W_{B}:1. When a DNS response is detected on connection ISP A, GW_{A} the connection ISP A, GW_{A} is set back to the weight W_{A}:1 as it is by default the primary connection. The connection ISP B, GW_{B} is set back to the weight W_{B}:100. Thus, the connection weights in IP stack table, table 4, are set back to the weights in IP stack table, table 2. When the DNS table and the IP stack table have been reconfigured, the process continues with the monitoring of the primary connection as described by steps 310 and 340.

The ACS functionality of a communications device may be implemented in digital electronically circuitry, or in computer hardware, firmware, software, or in combinations of them. Further, embodiments of the ACS function may be implemented in a computer program product in a machine readable storage device for execution by a programmable processor; and method steps of the invention may be performed by a programmable processor executing a program of instructions to perform functions of the invention by operating on input data and generating output.

Embodiments of the ACS function may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language or in assembly or machine language if desired; and in any case, the language may be a compiled or interpreted language.

Therefore, a computer program product may be implemented as a machine-readable medium that provides instructions, which when executed by a set of one or more processors, e.g. a controller 150, causing said set of processors to perform operations according to one or more of the above described steps 310-380.

Generally, a controller comprising a processor unit or a set of processor units will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such internal hard disks and removable disks; magneto-optical disks; and CD-ROM disks. Any of the foregoing may be supplemented by, or incorporated in, specially-designed ASICs (Application Specific Integrated Circuits).

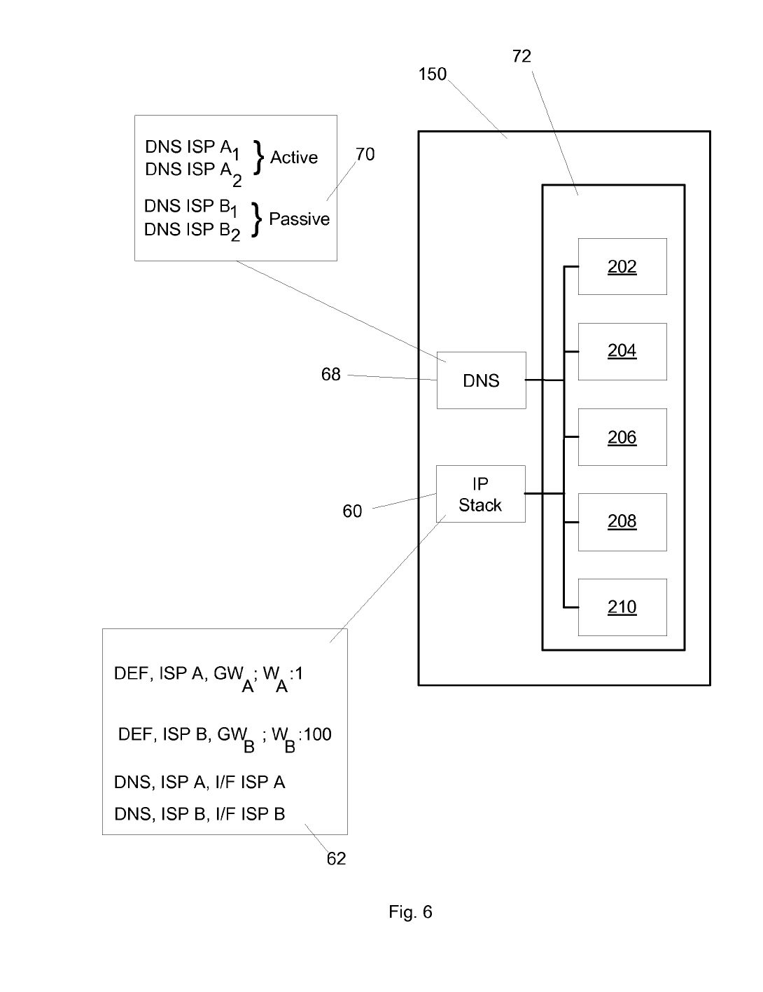

FIG. 6 is illustrating some embodiments of a controller 150 configured to perform the method steps of embodiments of the present Automatic Connection Selection functionality. The controller 150 is situated in a communications device supporting multi-access connection functionality and sending one or more Domain Name Server (DNS) Queries over one or more access connection(s) to DNS server(s), The controller 150 may be implemented as a controller 150 comprising a detecting block 202 configured to detect communication failure of an access connection used for data communication by monitoring reception of one or more expected Domain Name Server (DNS) Responses related to said sent Domain Name Server (DNS) Queries over said access connection used for data communication. The controller 150 further comprises a selection block 204 configured to select according to a selection criterion an access connection for data communication. The selection block 204 is configured to control the routing block 80 (see FIG. 3) or the sending block 82 (see FIG. 4) of a communications device 100. In some embodiments, each of said access connections have been dedicated a weight W corresponding to performance features of the connection and the selection criterion is to select the access connection with the lowest weight W to be used for data communication. In other embodiments, each of the access connections have been dedicated a weight W corresponding to performance features of the connection and the selection criterion is to select the working access connection with the highest weight to be used to be used for data communication.

The controller 150 may further comprise a sending block 206 which is configured to direct one or more Domain Name Server (DNS) Queries to all or a number of the DNS servers which is represented in a DNS table 70 in the DNS client 64 of the communications device. Said processor unit may comprise a state setting block 208 which is configured to set the DNS servers addresses in the DNS table in an active state or in a passive state. A DNS server address set in active state results in that the communications device sends DNS queries to corresponding DNS server. A DNS server address set in passive state results in that the communications device blocks the sending of DNS queries to corresponding DNS server.

The controller 150 may comprise a weight setting block 210 which is configured to handle connection weights in the routing table 62 of the IP stack 60. The weight setting block 210 may be configured to pre-set a connection as primary access connection as default at a set up process based on connection weights W. The setting block 210 is configured to individually set the weights of the connections according to a pre-set schedule at set up and mutually change the weights when communication failure is detected. The mutually changing of weights between connections in the routing table means that at least one connection's weights are set to a new value resulting in a change of access connection used for sending the data communication traffic. Thus, during the normal operation the DNS queries from the communications device are sent out only on the primary connection according to the connection weight setting and the responses from the DNS server(s) are monitored by the ACS function. The ACS function selects the “next best” connection based on the set weights, if the response from the DNS server(s) on the primary connection fails, The ACS function selects the third best connection based on weight, if the response from the DNS server(s) on the “next best” connection also fails. The controller 150 is configured to select the most favourable working access connection for the moment based on the connection weights. By changing the connection weights in the routing table, the controller 150 is able to select the most favourable connection for the moment,

In some embodiments of the controller 150 said weight setting block 210 is also configured to pre-set static routing posts in the IP stack routing table. The static routing posts, even denoted static routing rules, makes it possible for the controller to send DNS queries out on some of or all the other access connections when an access connection other than the primary connection has been selected for data communication.

Said weight setting block 210 may also be configured to redirect the data communication back to the primary access connection, if another connection is used than the primary connection for data communication, and a DNS response is received on the primary connection by reconfiguring the Domain Name Server table (70) and the access connection weights (W), and selecting the primary access connection according to the selection criteria.

One advantage with the present solution is that it provides automatic detection and selection of best possible working connection.

It further provides automatic failover to any number of secondary connections. Further one advantage is that it provides automatic return to any connection with higher preference, e.g. bandwidth, when available.

Yet another advantage is that the solution can easily be implemented in any communications device 100 having multiple connection options.

A number of embodiments of the present invention have been described. It will be understood that various modifications may be made without departing from the scope of the invention. Therefore, other implementations are within the scope of the following claims defining the invention.

1-14. (canceled)

15. Method for supporting multi-access connection functionality of a communications device comprising:
sending a plurality of Domain Name Server (DNS) queries, each DNS query being sent to a DNS over a different access connection;
detecting a communication failure of an access connection used for data communication by monitoring for reception of an expected DNS response related to one of the sent DNS queries;
selecting, according to a selection criterion, a working access connection for data communication.

16. The method of claim 15, wherein sending the plurality of DNS queries comprises sending a DNS query to a DNS having a DNS address that is represented in a DNS table in the communications device.

17. The method of claim 16, further comprising setting the DNS address in the DNS table to an active state.

18. The method of claim 15, wherein each of the access connections has a weight corresponding to performance features of the access connection.

19. The method of claim 18, wherein the selecting comprises selecting a working access connection with the highest weight.

20. The method of claim 18, wherein the selecting comprises selecting a working access connection with the lowest weight.

21. The method of claim 18, wherein the weights of the access connections are changed when an access connection for data communication has been selected according to the selection criterion.

22. The method of claim 18:
further comprising redirecting data communication to a primary access connection in response to receiving a DNS response on the primary access connection, the redirecting comprising:
reconfiguring the DNS table;
reconfiguring the access connection weights; and
selecting the primary access connection for data communication;
wherein the receiving the DNS response occurs while using an access connection distinct from the primary access connection for data communication;
wherein the primary access connection is pre-set as a default access connection at a set-up process.

23. A communications device supporting multi-access connection functionality, the communications device comprising:
a controller circuit configured to:
send a plurality of Domain Name Server (DNS) queries, each DNS query being sent to a DNS over a different access connection;
detect a communication failure of an access connection used for data communication by monitoring for reception of an expected DNS response related to one of the sent DNS queries;
select, according to a selection criterion, a working access connection for data communication.

24. The communications device of claim 23, wherein the controller circuit is further configured to send a DNS query to a DNS having a DNS address that is represented in a DNS table in the communications device.

25. The communications device of claim 24, wherein the controller circuit is further configured to set a DNS addresses in the DNS table to an active state.

26. The communications device of claim 23, wherein each of the access connections has a weight corresponding to performance features of the access connection.

27. The communications device of claim 26, wherein the controller circuit is configured to select the working access connection for data communication by selecting a working access connection with the highest weight.

28. The communications device of claim 26, wherein the controller circuit is configured to select the working access connection for data communication by selecting a working access connection with the lowest weight.

29. The communications device of claim 26, wherein the controller circuit is further configured to change the weights of the access connections when an access connection for data communication has been selected according to the selection criterion.

30. The communications device of claim 26:
wherein the controller circuit is further configured to redirect data communication to a primary access connection in response to receiving a DNS response on the primary access connection, the redirect comprising:
reconfiguring the DNS table;
reconfiguring the access connection weights; and
selecting the primary access connection for data communication;
wherein the receiving the DNS response occurs while using an access connection distinct from the primary access connection for data communication;
wherein the primary access connection is pre-set as a default access connection at a set-up process.
